(19) United States
(12) Patent Application Publication
(10) Pub. No.: US 2007/0287314 A1
(43) Pub. Date: Dec. 13, 2007

(54) Electrical connector having improved shield

(75) Inventor: Wen-Qiang Ma, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/811,520

(22) Filed: Jun. 11, 2007

(30) Foreign Application Priority Data
Jun. 9, 2006 (CN) 200620073494.7

(51) Int. Cl. H01R 29/00

(52) U.S. Cl. 439/188

(57) ABSTRACT

An electrical connector (1) includes an electrical element (3) a flexible printed circuit (2), a lower shield (10), and an upper shield (12). The lower shield has a bottom wall (101), a number of sidewalls (102), and a receiving space (100) defined therebetween. The flexible printed circuit is placed upon a number of flexible fingers (1011) formed on the bottom wall. The electrical element is placed upon the flexible printed circuit and urged thereby through the flexible fingers of the lower shield to bear against a top wall of the upper shield.

### BACKGROUND OF THE INVENTION

1. Field of the Invention

The present invention relates to an electrical connector, and particularly to an electrical connector in which an electrical element such as a camera module is firmly fitted.

2. Description of Prior Arts

An electrical connector for receiving a camera module is described in Chinese Patent No. CN 2,733,635Y, issued on Oct. 12, 2005, and comprises a shield, an insulative housing and a plurality of terminals mounted in sidewalls of the insulative housing. The shield surrounds the insulative housing and comprises four side walls, wherein a pair of opposite side walls has a pair of ground fingers extending downwardly therefrom and projecting inwardly not only for grounding the camera module but also for resisting against the camera module. However, the electrical connector described above can not provide sufficient resilient force to firmly fasten the camera module therein.

Hence, it is desirable to provide an improved electrical connector to overcome the aforementioned disadvantages.

### SUMMARY OF THE INVENTION

An object of the present invention is to provide an electrical connector adapted for firmly fastening an electrical element.

To achieve the above object, an electrical connector comprises an electrical element, a flexible printed circuit, a lower shield and an upper shield. The lower shield has a bottom wall, a number of sidewalls extending perpendicularly from the bottom wall, and a receiving space defined therebetween. The sidewall has at least one first spring tab and the bottom wall has a plurality of flexible fingers extending into the receiving space and providing an elastic force to the flexible printed circuit. The upper shield is secured to the lower shield and has at least one second spring tab. The flexible printed circuit is placed upon the flexible fingers of the lower shield. The electrical element is placed upon the flexible printed circuit and urged thereby through the flexible fingers of the lower shield to bear against the top wall of the upper shield.

Other objects, advantages and novel features of the invention will become more apparent from the following detailed description of the present embodiment when taken in conjunction with the accompanying drawings.

### BRIEF DESCRIPTION OF THE DRAWING

FIG. 1 is an exploded perspective view of an upper shield and a lower shield of an electrical connector in accordance with the present invention;

FIG. 2 is an assembled perspective view of the electrical connector; and

FIG. 3 is a perspective view of the lower shield.

### DETAILED DESCRIPTION OF THE PREFERRED EMBODIMENT

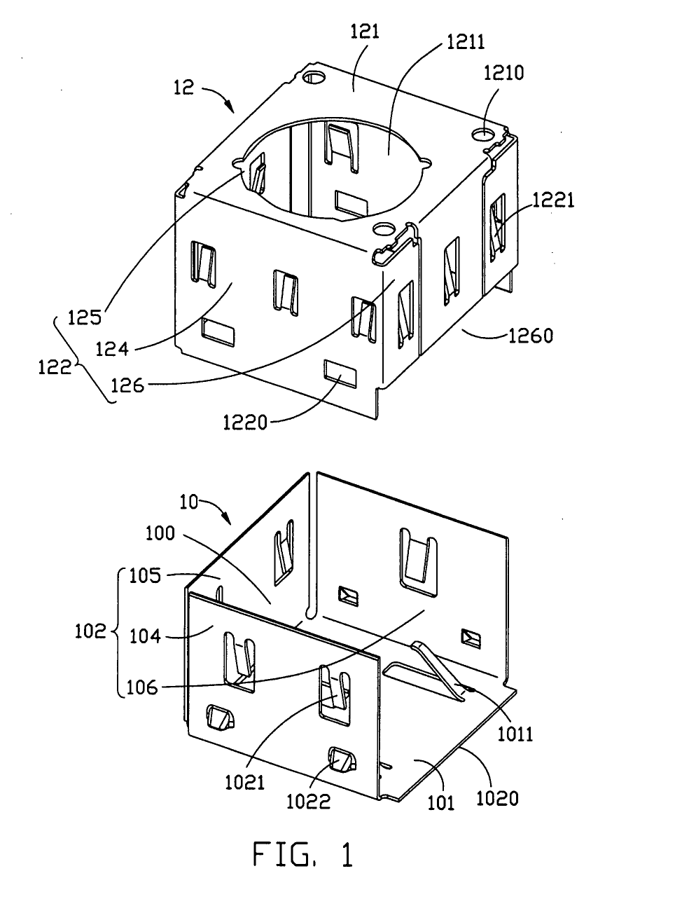

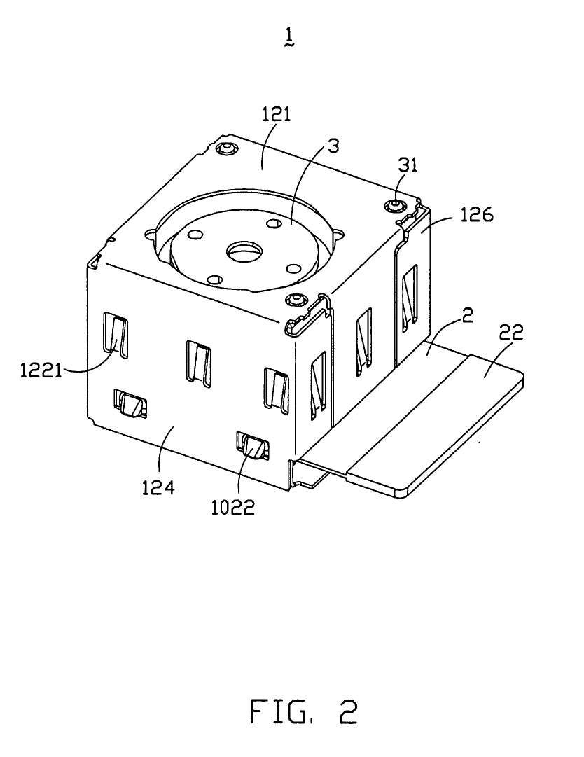

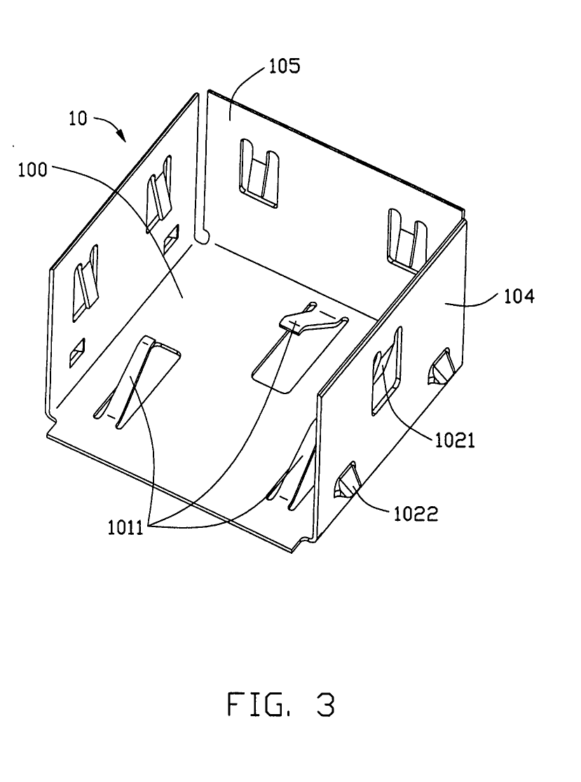

Reference will now be made to the drawing figures to describe the present invention in detail. Referring to FIGS. 1-3, an electrical connector 1 in accordance with the present invention comprises a lower shield 10 defining a receiving space 100, an upper shield 12 enclosing the lower shield 10, an electrical element 2 and a flexible printed circuit 2 having a first portion (not shown) and a second portion 22. The electrical element referred to in this embodiment is a camera module 3.

The lower shield 10 has a bottom wall 101 and a plurality of sidewalls 102 and defines a receiving space 100 therein. The sidewalls 102 comprise a pair of opposite lateral walls 104 and an end wall 105 disposed between the opposite lateral walls 104. An opening 106 is provided corresponding to the upper shield 12 for allowing the second portion 22 of the flexible printed circuit 2 to be exposed outwardly, as will be described later. Each lateral wall 104 has a plurality of protrusions 1022 projecting outwardly therefrom and a plurality of first spring tabs 1021 extending inwardly for fastening the camera module 3. The bottom wall 101 has a plurality of flexible fingers 1011 extending into the receiving space 100 for abutting against a bottom surface of the flexible printed circuit 2 and for providing an elastic force against the camera module 3 resiliently.

The upper shield 12 comprises a top wall 121 and a plurality of side walls 122. The side walls 122 further comprise a primary wall 126, a pair of vertical walls 124 and an end wall 125. The top wall 121 has a central hole 1211 for partial extension of the camera module 3 and a plurality of holes 1210 for engaging with a plurality of embosses 31 projecting upwardly from the camera module 3. A plurality of recesses 1220 are disposed on the vertical wall 124 for receiving the protrusions 1022 of the sidewalls 102 of the lower shield 10. Each of the walls 124 and the wall 125 has a plurality of second spring tabs 1221 extending inwardly for abutting against the lower shield 10. The primary wall 126 has a cutout 1260 defined on a lower portion thereof for extension of the second portion 22 of the flexible printed circuit 2.

In assembling of the electrical connector, firstly, the flexible printed circuit 2 and the camera module 3 are assembled in the receiving space 10 of the lower shield 10 in sequence. The first portion of the flexible printed circuit 2 is located in the receiving space 100, with a top surface thereof contacting with the camera module 3 and a bottom surface thereof being resisted against by the flexible fingers 1011, and therefore the flexible print circuit 2 firmly abuts the camera module 3. At that time, the first spring tabs 1021 of the sidewalls 102 firmly fasten the camera module 3. Secondly, the upper shield 12 encloses the lower shield 10, with the protrusions 1022 of the sidewall 102 being received in the corresponding recesses 1220 for fastening the upper shield 12 to the lower shield 10. At the same time, the second portion 22 of flexible print circuit 2 extends outwardly though the cutout 1260 for electrically connecting to a printed circuit board or another board mounted connector (not shown). Finally, the camera module 3 is firmly supported by the flexible fingers 1011 of lower shield 10 in view of the engagement between the protrusions 1022 of the lower shield 10 and the recesses 1220 of the upper shield 12. In another embodiment, the protrusions 1022 may be disposed on the upper shield 12 and the recesses 1220 may be disposed on the lower shield 10. Certainly, various configurations of the protrusions 1022 and the recesses 1220 for engaging with each other are contemplated.

Advantages of the present invention are to provide a lower shield formed with a bottom wall which has a plurality of flexible fingers having sufficient resilient force for adequately positioning the electrical element and with a plurality of sidewalls having a number of protrusions for engaging with the upper shield. The electrical element can be firmly fastened to the electrical connector via not only the resilient support of flexile fingers but also the engagement between the protrusions and the recesses. The design of the flexible fingers of the lower shield is so simple and effective that it is easy to manufacture, and a lot of material could be saved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claim is:

1. An electrical connector comprising:
a lower shield having a bottom wall, a plurality of sidewalls extending perpendicularly from the bottom wall, and a receiving space defined therebetween, said sidewall having at least one first spring tab, said bottom wall having a plurality of flexible fingers extending into the receiving space and providing an elastic force to the flexible printed circuit;
an upper shield secured to the lower shield and comprising a plurality of side walls each having at least one second spring tab and a top wall;
a flexible printed circuit placed upon the flexible fingers of the lower shield; and
an electrical element placed upon the flexible printed circuit and being urged thereby through the flexible fingers of the lower shield to bear against the top wall of the upper shield.

2. The electrical connector as claimed in claim 1, wherein said top wall of the upper shield defines a central hole for partially exposing said electrical element and a plurality of holes for engaging with a plurality of embosses projecting upwardly from the electrical element.

3. The electrical connector as claimed in claim 1, wherein said side walls of the upper shield comprise an end wall, a pair of vertical walls and a primary wall.

4. The electrical connector as claimed in claim 3, wherein said sidewalls of the lower shield comprise a pair of opposite lateral walls and an end wall disposed between the opposite lateral walls and an opening is defined opposite to the end wall for allowing an end of the flexible printed circuit to extend outwardly.

5. The electrical connector as claimed in claim 3, wherein said primary wall of the upper shield defines a cutout and wherein the flexible printed circuit comprises a first portion received in the receiving space and a second portion extending outwardly through the cutout.

6. An electrical connector assembly comprising:
an upper shell including one top wall and at least two side walls, a through hole formed in the top wall, and a first retention device formed in each of said side walls;
a lower shell including a bottom plate and at least two side plates, a plurality of spring fingers integrally upwardly extending from the bottom plate, and a second retention device formed in each of said side plates so as to cooperate with the first retention device to assemble the upper shell and the lower shell together under a condition that a combination of said upper shell and the lower shell commonly defines a receiving cavity;
a camera module received in said receiving cavity, and a flexible printed circuit board engaged with an underside of said camera module and laterally extending out of said receiving cavity; wherein said spring arms not only retain the camera module in an uppermost position in the receiving cavity so as to cooperate with the top wall to vertically hold the camera module in position but also upwardly press the flexible printed circuit against the upper side of the camera module.

7. The electrical connector assembly as claimed in claim 6, wherein a plurality of retention tangs extend from at least either the side walls or the side plates to laterally abut against the camera module for horizontally holding the camera module in position.

8. The electrical connector assembly as claimed in claim 6, wherein the upper shell includes four side walls.

9. The electrical connector assembly as claimed in claim 6, wherein the lower shell includes three side plates.

10. The electrical connector assembly as claimed in claim 6, wherein at least either the side walls or the side plates form a plurality of spring arms extending toward and engaging the other for enhancing shielding therebetween.

11. The electrical connector assembly as claimed in claim 6, where the side plates are located inside of the side walls.
